(19) United States
(12) Patent Application Publication
(10) Pub. No.: US 2007/0209161 A1
(43) Pub. Date: Sep. 13, 2007

(54) GRIPPING AID FOR ARRANGEMENT ON AN ARTICLE OF DAILY USE

(76) Inventors: James Neering, Fulda (DE); Scott Edward Cummings, Fulda (DE)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/616,580

(22) Filed: Dec. 27, 2006

(30) Foreign Application Priority Data
Dec. 30, 2005 (DE) 10 2005 063 153.3

(51) Int. Cl. A47J 43/28; B25G 3/32

(52) U.S. Cl. 16/422; 30/322

(57) ABSTRACT

The invention relates to a gripping aid (01, 09) for arrangement on an article of daily use, more preferably for arrangement on cutlery items (02). Here, the gripping aid (01, 09) is formed as a grip body (03, 10) the outside of which at least by areas forms a gripping surface (04) wherein an attachment facility (07, 11) is provided on the grip body (03, 10) with which the grip body (03, 10) can be detachably fixed to the article of daily use (02).

### CROSS-REFERENCE TO RELATED APPLICATIONS

The present patent application claims priority from German Patent Application No. 10 2005 063 153.3, filed on Dec. 30, 2005.

### BACKGROUND OF THE INVENTION

1). Field of the Invention

The invention relates to a gripping aid for arrangement on an article of daily use according to the preamble of claim 1.

2). Discussion of Related Art

These types of gripping aids are preferably but by no means exclusively used to facilitate the gripping of articles of daily use for people with restricted mobility of the hands. More preferably in the case of persons with hand injuries or older persons where the mobility of the hands is reduced because of arthritic changes to the joints, these types of gripping aids are of considerable importance.

The problem of the present invention is to propose a new type of gripping aid which allows flexible use of the gripping aid with maximum handling comfort.

### SUMMARY OF THE INVENTION

The gripping aid according to the invention is based on the idea that the gripping aid is not permanently joined with the article of daily use but is affixed to the article of daily use optionally detachable. As a result, this makes it possible for the gripping aid to be employed as required using standard articles of daily use, for instance standard cutlery items. As soon as a certain article of daily use is no longer required by the user the gripping aid can be detached from the article of daily use and attached to another article of daily use. Because of this detachability of the grip body the gripping aid itself can be equipped suitably comfortably, more preferably have a gripping surface. When using the gripping aid for the handling of cutlery items while taking in food, assistance through care personnel for feeding the patient can be cut in many cases.

The embodiment of the grip body of the gripping aid according to the invention is basically random. Gripping bodies with largely cylindrical design offer particularly high handling comfort while the cylindrical body should preferably be a crowned design so that it can be comfortably held in the palm of the hand.

The length of the cylindrical grip body should preferably correspond to the width of a human hand.

In order to be able to flexibly adapt to the gripping habits of different users the grip body should preferably be elastically deformable. Depending on the type of gripping restrictions of the user the grip body can then be gripped appropriately loosely or firmly.

The grip body can be produced particularly economically from foam rubber while the foam rubber enables the elastic deformation of the grip body at the same time.

The way in which the article of daily use is attached to the grip body is basically random. It is particularly economical if the grip body has a recess for attaching the article of daily use in which the article of daily use is inserted. In this way it is possible to do without additional means of attachment on the grip body.

To enable reliable fixing of the grip body to the article of daily use in an easy manner the cross section of the recess serving as attachment facility should be at least slightly smaller than the article of daily use to be inserted in it. When inserting the article of daily use in the recess the grip body elastically hugs the item of daily use in the contact area so that the grip body is positively and/or non-positively joined with the article of daily use.

The recess for attachment of the article of daily use should preferably have a slit-type cross-section. Such an attachment slit can be produced from the grip body without stock removal and additionally allows secure fixing of the grip body to the article of daily use.

A Further simplification of the manufacture is obtained if the recess is formed in the way of a through opening. In this way it is possible for instance to easily and economically produce the recess by punching the through opening.

The relative position between article of daily use and gripping aid is determined by the relative arrangement of the through opening in the grip body. Here, it has proved particularly advantageous if the through opening runs along the center axis of the grip body since intuitively good handling of the article of daily use, especially cutlery items, guided by the grip body, is made possible.

More preferably if the grip body itself is not elastically deformable can secure fixing of the grip body to the article of daily use be ensured in that elastically deformable attachment lugs, for instance of elastomer material, are provided in the contact area.

### BRIEF DESCRIPTION OF THE DRAWINGS

Various embodiments of the invention are schematically shown in the drawings and are explained in the following as example.

It shows:

FIG. 1 a first embodiment of a gripping aid for arrangement on a spoon in perspective view;

FIG. 2 the gripping aid according to FIG. 1 after removal of the spoon in perspective view;

FIG. 3 the gripping aid according to FIG. 2 in lateral view;

FIG. 4 the gripping aid according to FIG. 3 in cross section along the section line A-A;

FIG. 5 a second embodiment of a gripping aid in perspective view;

FIG. 6 the gripping aid according to FIG. 5 in lateral view; and

FIG. 7 the gripping aid according to FIG. 6 in cross section along the section line B-B.

### DETAILED DESCRIPTION OF THE INVENTION

FIG. 1 shows a gripping aid 01 which is more preferably intended for arrangement on cutlery items, in the example shown on a spoon 02. The gripping aid 01 has a grip body 03 which is made from elastically deformable foam rubber. The cylindrical grip body 03 forms a crown-shaped gripping surface 04 on its circumferential surface which can be gripped comfortably and easily in the hands of users with restricted mobility. The length of the grip body 03 between the two cover surfaces 05 and 06 here roughly correspond to the width of a human hand.

To attach the spoon 02 to the grip body 03 of a slit-type through opening 07 is provided into which the spoon 02 with its narrow end can be optionally inserted starting from the cover surface 05 or the cover surface 06.

Because of the slit-type cross section of the through opening 07 which is smaller than the cross section of the spoon 02, the elastically deformable grip body 03 positively and non-positively hugs the stem of the spoon 02.

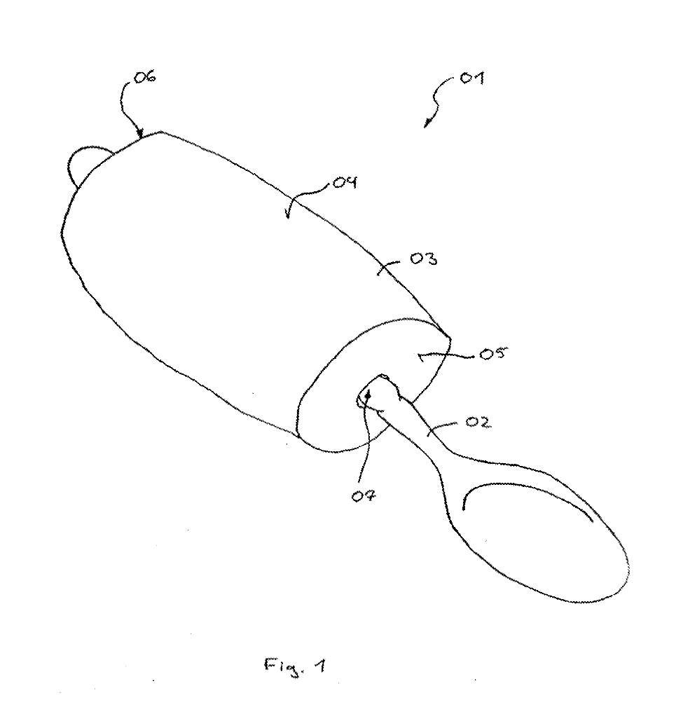

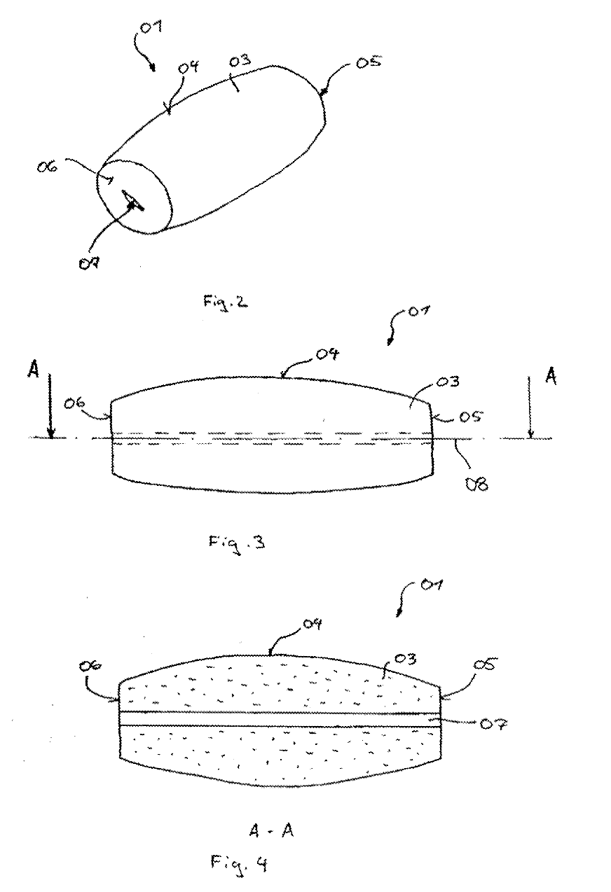

From FIG. 3 and FIG. 4 it is evident that the gripping surface 03 is crowned, i.e. arched outward convexly to favorably hug the palm of the user for gripping. The through opening 07 extends along the center axis 08 of the grip body 03 of foam rubber.

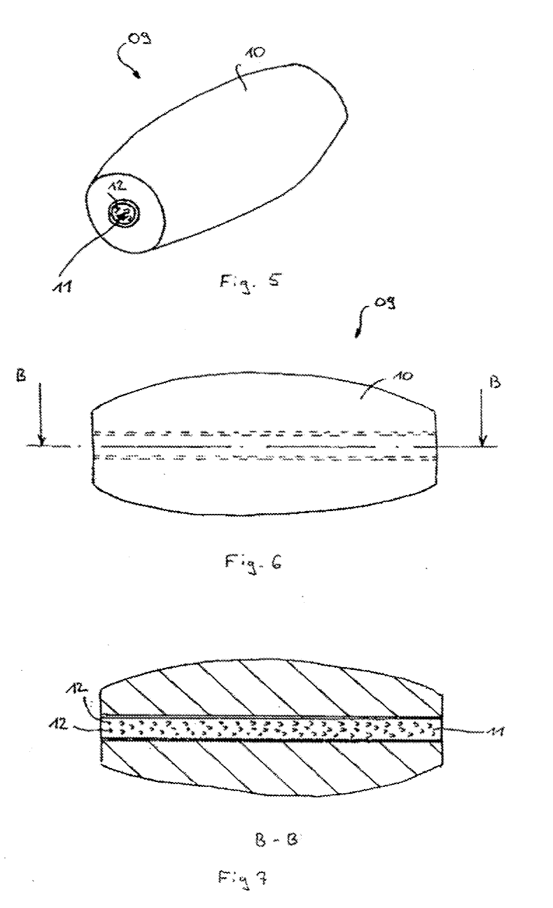

FIG. 5 to FIG. 7 show a second embodiment 09 of a gripping aid according to the invention. The grip body 10 of the gripping aid 09 in its fundamental construction largely corresponds to the grip body 03, wherein, however, the grip body 10 is manufactured from a non-deformable material, for instance solid plastic. In order for instance to fix a spoon 02 to the grip body 10 a large number of elastically deformable attaching lugs 12 are provided in the through opening 11 of the grip body 10 which elastically hug the stem of the spoon when the spoon 02 is inserted.

What is claimed is:

1. A gripping aid (01, 09) for arrangement on an article of daily use, more preferably for arrangement on cutlery items (02), characterized in that the gripping aid (01, 09) is formed as grip body (03, 10) the outside of which at least by areas forms a gripping surface (04) wherein an attachment facility (07, 11) is provided on the grip body (03, 10) with which the grip body can be detachably fixed to the article of daily use (02).

2. The gripping aid according to claim 1, characterized in that the grip body (03, 10) has a largely cylindrical form.

3. The gripping aid according to claim 1, characterized in that the grip body (03, 10) has a spherically shaped gripping surface (04).

4. The gripping aid according to claim 1, characterized in that the length of the grip body (03, 10) corresponds to the width of a human hand.

5. The gripping aid according to claim 1, characterized in that the grip body (03) is elastically deformable.

6. The gripping aid according to claim 1, characterized in that the grip body (03) is manufactured of foam rubber.

7. The gripping aid according to claim 1, characterized in that the attachment facility is formed in the way of a recess (07, 11) in the grip body (03, 10) into which the article of daily use (02) can be inserted from the outside.

8. The gripping aid according to claim 7, characterized in that the cross section of the recess (07) is at least slightly smaller than the cross section of the article of daily use (02) while the grip body (03) can elastically hug the article of daily use (02) at least by areas in the contact area to the article of daily use (02).

9. The gripping aid according to claim 7, characterized in that the cross section of the recess (07) is formed slit-like.

10. The gripping aid according to claim 7, characterized in that the recess (07, 11) is formed in the way of a through opening.

11. The gripping aid according to claim 10, characterized in that the through opening (07, 11) opens out on the cover surfaces (05, 06) of the grip body (03, 10) of the gripping aid (01, 09).

12. The gripping aid according to claim 11, characterized in that the through opening (07, 11) extends along the center axis (08) of the grip body (03, 10).

13. The gripping aid according to claim 1, characterized in that in the contact area of the grip body (09) to the article of daily use (02) elastically deformable attachment lugs (12) are provided.
